(19) United States
(12) Patent Application Publication
(10) Pub. No.: US 2024/0235662 A9
(43) Pub. Date: Jul. 11, 2024

(54) NARROWBAND INTERNET OF THINGS BASED COMMUNICATION METHOD AND APPARATUS

(71) Applicant: Huawei Technologies Co., Ltd., Shenzhen (CN)

(72) Inventors: Jingwei Zhang, Hangzhou (CN); Tianhang Yu, Hangzhou (CN); Hejia Luo, Hangzhou (CN); Shengchen Dai, Hangzhou (CN); Yunfei Qiao, Hangzhou (CN); Rong Li, Boulogne Billancourt (FR); Jun Wang, Hangzhou (CN)

(21) Appl. No.: 18/400,101

(22) Filed: Dec. 29, 2023

Related U.S. Application Data
(63) Continuation of application No. PCT/CN2022/097462, filed on Jun. 7, 2022.

(30) Foreign Application Priority Data
Jun. 30, 2021 (CN) 202110739655.0

(51) Int. Cl. H04B 7/185

(52) U.S. Cl. CPC H04B 7/18532

(57) ABSTRACT

This application discloses a NB-IoT-based communication method and an apparatus, to evolve a NB-IoT communication technology into an NTN. The method is as follows: A terminal device generates an uplink signal, including a superframe which includes a synchronization sequence located in first duration of the superframe and a data frame located in second duration which is after the first duration, the synchronization sequence successively includes a first sequence repeated Ni times and a second sequence repeated N2 times, the second sequence is obtained by multiplying the first sequence by −1, a part of consecutive sequences of the synchronization sequence are used as a first synchronization reference sequence that is obtained based on the second sequence repeated N2 times and one or more first sequences that are sorted from back to front in the first sequence repeated N1 times. The terminal device sends the uplink signal to a network device.

### CROSS-REFERENCE TO RELATED APPLICATIONS

This application is a continuation of International Patent Application No. PCT/CN2022/097462, filed on Jun. 7, 2022, which claims priority to Chinese Patent Application No. 202110739655.0, filed on Jun. 30, 2021. The disclosures of the aforementioned applications are hereby incorporated by reference in their entireties.

### TECHNICAL FIELD

Embodiments of this application relate to the field of communication technologies, and in particular, to a narrowband internet of things-based communication method and an apparatus.

### BACKGROUND

In terrestrial communication, the narrowband internet of things (NB-IoT) features a narrow bandwidth, low costs, low power consumption, and flexible deployment and can implement functions such as intelligent identification, positioning, tracking, and management, and therefore is widely used in intelligent transportation, smart home, smart healthcare, environment monitoring, and the like.

Currently, various research institutions are studying evolution of terrestrial communication technologies and protocols to non-terrestrial network (NTN) communication. The NTN communication may be, for example, satellite communication. In satellite communication, especially in a satellite mobile communication system, it is difficult to use the narrowband internet of things in satellite communication due to a relatively large transmission delay.

How to evolve a narrowband internet of things communication technology into an NTN is a problem that needs to be resolved.

### SUMMARY

Embodiments of this application provide a narrowband internet of things-based communication method and an apparatus, to evolve a narrowband internet of things communication technology into an NTN.

According to a first aspect, a narrowband internet of things-based communication method is provided. The method is applied to a non-terrestrial network NTN. The method may be performed by a terminal device or a chip, a chip system, or a circuit located in the terminal device. The method may be implemented by using the following steps: The terminal device generates an uplink signal. A frame structure of the uplink signal includes a superframe. One superframe includes a synchronization sequence and a data frame. The synchronization sequence is located in first duration of the superframe. The data frame is located in second duration of the superframe. The first duration of the superframe is before the second duration. The synchronization sequence is formed by repeating a sequence of a type N times. The synchronization sequence successively includes a first sequence repeated N1 times and a second sequence repeated N2 times. The second sequence is obtained by multiplying the first sequence by −1. Alternatively, it may be considered that the first sequence is positive and the second sequence is negative, or a symbol of the second sequence is opposite to a symbol of the first sequence, or the first sequence and the second sequence are in a positive-negative relationship. For example, the first sequence is a, and the second sequence is −a. A part of sequences of the synchronization sequence are used as a synchronization reference sequence, which may be denoted as a first synchronization reference sequence. The first synchronization reference sequence may be obtained based on the second sequence repeated N2 times and one or more first sequences that are sorted from back to front in the first sequence repeated N1 times. In other words, the first synchronization reference sequence includes the second sequence repeated N2 times and the one or more first sequences connected to the second sequence repeated N2 times. N, N1, and N2 are all positive integers, N is greater than 2, and N2 is greater than 1. The terminal device sends the uplink signal to a network device.

According to the foregoing method, the network device does not need to deliver a synchronization signal to the terminal device, and the terminal device may directly send the uplink signal to the network device. In addition, using a frame structure design of the uplink signal can achieve synchronization after the network device receives the uplink signal. The terminal device uses an asynchronous communication mode, so that transmission overheads of delivering an ephemeris by the network device can be saved, time overheads caused by synchronization performed before data transmission can be reduced, and power consumption and overheads caused by synchronization and decoding on the terminal device can be reduced. Because there are a plurality of second sequences in the synchronization reference sequence, when cross-correlation is performed, there is a relatively long reduction interval during window sliding. This can implement performance loss compensation and facilitate synchronization.

According to a second aspect, a narrowband internet of things-based communication method is provided. The method is applied to a non-terrestrial network NTN. The method may be performed by a network device or a chip, a chip system, or a circuit located in the network device. The network device may be a satellite. The method may be implemented by using the following steps: The network device receives an uplink signal. A frame structure of the uplink signal includes a superframe. One superframe includes a synchronization sequence and a data frame. The synchronization sequence is located in first duration of the superframe. The data frame is located in second duration of the superframe. The first duration of the superframe is before the second duration. The synchronization sequence is formed by repeating a sequence of a type N times. The synchronization sequence successively includes a first sequence repeated N1 times and a second sequence repeated N2 times. The second sequence is obtained by multiplying the first sequence by −1. Alternatively, it may be considered that the first sequence is positive and the second sequence is negative, or a symbol of the second sequence is opposite to a symbol of the first sequence, or the first sequence and the second sequence are in a positive-negative relationship. For example, the first sequence is a, and the second sequence is −a. A part of sequences of the synchronization sequence may be used as a synchronization reference sequence, which may be denoted as a first synchronization reference sequence. The first synchronization reference sequence may be obtained based on the second sequence repeated N2 times and one or more first sequences that are sorted from back to front in the first sequence repeated N1 times. In other words, the first synchronization reference sequence may include the second sequence repeated N2 times and the one or more first sequences connected to the second sequence repeated N2 times. N, N1, and N2 are all positive integers, N is greater than 2, and N2 is greater than 1. The network device performs uplink synchronization based on a second synchronization reference sequence and the received uplink signal. The second synchronization reference sequence may be locally pre-stored by the network device.

According to the foregoing method, the network device does not need to deliver a synchronization signal to a terminal device, and the terminal device may directly send the uplink signal to the network device. In addition, using a frame structure design of the uplink signal can achieve synchronization after the network device receives the uplink signal. The terminal device uses an asynchronous communication mode, so that transmission overheads of delivering an ephemeris by the network device can be saved, time overheads caused by synchronization performed before data transmission can be reduced, and power consumption and overheads caused by synchronization and decoding on the terminal device can be reduced. In the frame structure, the synchronization reference sequence may be used by a receive end to perform cross-correlation with a synchronization sequence in a received signal when the receive end receives the signal, so as to implement synchronization. Because there are a plurality of second sequences in the synchronization reference sequence, when cross-correlation is performed, there is a relatively long reduction interval during window sliding. This can implement performance loss compensation and facilitate synchronization.

With reference to the second aspect, this application may provide the following possible designs.

In a possible design, uplink synchronization may include frequency offset estimation and frame structure determining, and the frame structure determining includes distinguishing between a location of the synchronization sequence and a location of the data frame. The network device may perform cross-correlation based on a second reference sequence and the received uplink signal. A cross-correlation amplitude location may be used to determine the location of the synchronization sequence and the location of the data frame.

In a possible design, there may be a plurality of second synchronization reference sequences. The network device performs cross-correlation between the uplink signal and each of the plurality of second synchronization reference sequences, to obtain cross-correlation amplitudes corresponding to the plurality of second synchronization reference sequences, where the plurality of second synchronization reference sequences are in a one-to-one correspondence with a plurality of subcarrier spacings; and the network device determines a subcarrier spacing corresponding to a second synchronization reference sequence with a largest cross-correlation amplitude as a subcarrier spacing used by the terminal device. The plurality of second synchronization reference sequences are in the one-to-one correspondence with the plurality of subcarrier spacings, so that the terminal device can transmit the uplink signal by using different subcarrier spacings. Optionally, the network device may further determine, based on the determined subcarrier spacing used by the terminal device, a frame structure corresponding to the subcarrier spacing, so as to parse the received uplink signal based on the frame structure, to obtain correct data.

In another possible design, the network device descrambles the uplink signal by using a plurality of scrambling sequences, to obtain a plurality of descrambled signals corresponding to the plurality of scrambling sequences, where the plurality of scrambling sequences are in a one-to-one correspondence with a plurality of subcarrier spacings; the network device performs cross-correlation between each of the plurality of descrambled signals and the second synchronization reference sequence, to obtain a plurality of cross-correlation amplitudes corresponding to the plurality of scrambling sequences; and the network device determines a subcarrier spacing corresponding to a scrambling sequence with a largest cross-correlation amplitude as a subcarrier spacing used by the terminal device. The plurality of scrambling sequences are in the one-to-one correspondence with the plurality of subcarrier spacings, so that the terminal can transmit the uplink signal by using different subcarrier spacings. Optionally, the network device may further determine, based on the determined subcarrier spacing used by the terminal device, a frame structure corresponding to the subcarrier spacing, so as to parse the received uplink signal based on the frame structure, to obtain correct data.

In a possible design, a 1^{st} superframe of the uplink signal may carry first control information, and the first control information indicates a subcarrier spacing used for transmission of a subsequent superframe after the 1^{st} superframe. The subcarrier spacing is explicitly indicated, so that the terminal can transmit the uplink signal by using different subcarrier spacings. Optionally, the network device may further determine, based on the subcarrier spacing, a frame structure corresponding to the subcarrier spacing, so as to parse the received uplink signal based on the frame structure, to obtain correct data.

With reference to the first aspect and the second aspect, the following provides some possible designs:

In a possible design, a subcarrier spacing used to generate the uplink signal may be 60 kHz, a length of the first duration is 40 milliseconds (ms), a length of the second duration is 60 ms, the data frame includes six radio frames, and a length of each radio frame is 10 ms.

When the subcarrier spacing used to generate the uplink signal may be 60 kHz, the length of the first duration is 40 ms, the length of the second duration is 60 ms, the data frame includes the six radio frames, and the length of each radio frame is 10 ms, in a possible design, the first sequence and the second sequence each are a Golay sequence whose length may be 64, N=37, N1=32, and N2=5. Optionally, the synchronization reference sequence includes a 32^{nd} first sequence and five second sequences. In another possible design, the first sequence and the second sequence each may be an M-sequence whose length is 63, and N=38.

In another possible design, a subcarrier spacing used to generate the uplink signal may be 15 kHz, a length of the first duration is 20 ms, a length of the second duration is 80 ms, the data frame includes two radio frames, and a length of each radio frame is 40 ms.

When the subcarrier spacing used to generate the uplink signal may be 15 kHz, the length of the first duration is 20 ms, the length of the second duration is 80 ms, the data frame includes the two radio frames, and the length of each radio frame is 40 ms, in a possible design, the first sequence and the second sequence each may be a Golay sequence whose length is 16, and N=18; or the first sequence may be an M-sequence whose length is 15, and N=20. In another possible design, the first sequence and the second sequence each may be an M-sequence whose length is 15, and N=20.

In still another possible design, a subcarrier spacing used to generate the uplink signal may be 30 kHz, a length of the first duration is 40 ms, a length of the second duration is 60 ms, the data frame includes three radio frames, and a length of each radio frame is 20 ms.

When the subcarrier spacing used to generate the uplink signal may be 30 kHz, the length of the first duration is 40 ms, the length of the second duration is 60 ms, the data frame includes the three radio frames, and the length of each radio frame is 20 ms, in a possible design, the first sequence and the second sequence each are a Golay sequence whose length may be 32, and N=37. In another possible design, the first sequence and the second sequence each may be an M-sequence whose length is 31, and N=38.

In a possible design, the data frame in the superframe of the uplink signal includes one or more radio frames, a first radio frame in the one or more radio frames carries second control information, and the first radio frame may be a 1^{st} radio frame in the one or more radio frames. The second control information indicates a quantity of times of repeated transmission of the superframe. A satellite link budget can be compensated by repeatedly transmitting the superframe, and reliability of data transmission can be improved.

In a possible design, a first frequency hopping mode is used for transmission between a plurality of superframes to implement transmission of the uplink signal, in other words, the first frequency hopping mode is used for transmission between the plurality of superframes during transmission of the uplink signal.

In a possible design, the synchronization sequence may be transmitted in the superframe by using a second frequency hopping mode, and/or the data frame includes one or more radio frames, and the one or more radio frames are transmitted in the superframe by using a third frequency hopping mode. Frequency hopping transmission can resist interference and improve system reliability.

Optionally, the first frequency hopping mode, the second frequency hopping mode, and the third frequency hopping mode may be a same frequency hopping mode. The third frequency hopping mode may be a fixed frequency hopping mode or may be an unfixed frequency hopping mode.

In a possible design, the uplink signal in the foregoing designs may be transmitted based on a single carrier.

According to a third aspect, a communication apparatus is provided. The apparatus is applied to a non-terrestrial network NTN. The apparatus has functions of implementing the method according to any one of the first aspect or the possible designs of the first aspect. The functions may be implemented by hardware, or may be implemented by hardware executing corresponding software. The hardware or the software includes one or more modules corresponding to the foregoing functions. In a design, the apparatus may include a processing module and a communication module. For example, the processing module is configured to generate an uplink signal. A frame structure of the uplink signal includes a superframe. One superframe includes a synchronization sequence and a data frame. The synchronization sequence is located in first duration of the superframe. The data frame is located in second duration of the superframe. The first duration of the superframe is before the second duration. The synchronization sequence is formed by repeating a sequence of a type N times. The synchronization sequence successively includes a first sequence repeated N1 times and a second sequence repeated N2 times. The second sequence is obtained by multiplying the first sequence by −1. Alternatively, it may be considered that the first sequence is positive and the second sequence is negative, or a symbol of the second sequence is opposite to a symbol of the first sequence, or the first sequence and the second sequence are in a positive-negative relationship. For example, the first sequence is a, and the second sequence is −a. A part of sequences of the synchronization sequence are used as a synchronization reference sequence, which may be denoted as a first synchronization reference sequence. The first synchronization reference sequence may be obtained based on the second sequence repeated N2 times and the last one or more first sequences in the first sequence repeated N1 times. In other words, the first synchronization reference sequence includes the second sequence repeated N2 times and the one or more first sequences connected to the second sequence repeated N2 times. N, N1, and N2 are all positive integers, N is greater than 2, and N2 is greater than 1. The communication module is configured to send the uplink signal to a network device.

According to a fourth aspect, a communication apparatus is provided. The apparatus is applied to a non-terrestrial network NTN. The apparatus has functions of implementing the method according to any one of the second aspect or the possible designs of the second aspect. The functions may be implemented by hardware, or may be implemented by hardware executing corresponding software. The hardware or the software includes one or more modules corresponding to the foregoing functions. In a design, the apparatus may include a processing module and a communication module. For example, the communication module is configured to receive an uplink signal. A frame structure of the uplink signal includes a superframe. One superframe includes a synchronization sequence and a data frame. The synchronization sequence is located in first duration of the superframe. The data frame is located in second duration of the superframe. The first duration of the superframe is before the second duration. The synchronization sequence is formed by repeating a sequence of a type N times. The synchronization sequence successively includes a first sequence repeated N1 times and a second sequence repeated N2 times. The second sequence is obtained by multiplying the first sequence by −1. Alternatively, it may be considered that the first sequence is positive and the second sequence is negative, or a symbol of the second sequence is opposite to a symbol of the first sequence, or the first sequence and the second sequence are in a positive-negative relationship. For example, the first sequence is a, and the second sequence is −a. A part of sequences of the synchronization sequence are used as a synchronization reference sequence, which may be denoted as a first synchronization reference sequence. The first synchronization reference sequence may be obtained based on the second sequence repeated N2 times and the last one or more first sequences in the first sequence repeated N1 times. To be specific, the first synchronization reference sequence is obtained based on the second sequence repeated N2 times and one or more first sequences that are sorted from back to front in the first sequence repeated N1 times. The first synchronization reference sequence includes the second sequence repeated N2 times and the one or more first sequences connected to the second sequence repeated N2 times. N, N1, and N2 are all positive integers, N is greater than 2, and N2 is greater than 1. The processing module is configured to perform uplink synchronization based on a second synchronization reference sequence and the received uplink signal.

With reference to the fourth aspect, in a first possible design of the fourth aspect, there may be a plurality of second synchronization reference sequences; and the processing module is further configured to: perform cross-correlation between the uplink signal and each of the plurality of second synchronization reference sequences, to obtain cross-correlation amplitudes corresponding to the plurality of second synchronization reference sequences, where the plurality of second synchronization reference sequences are in a one-to-one correspondence with a plurality of subcarrier spacings; and determine a subcarrier spacing corresponding to a synchronization reference sequence with a largest cross-correlation amplitude as a subcarrier spacing used by a terminal device. Optionally, the processing module is further configured to determine, based on the determined subcarrier spacing used by the terminal device, a frame structure corresponding to the subcarrier spacing.

With reference to the fourth aspect, in a second possible design of the fourth aspect, the processing module is further configured to: descramble the uplink signal by using a plurality of scrambling sequences, to obtain a plurality of descrambled signals corresponding to the plurality of scrambling sequences, where the plurality of scrambling sequences are in a one-to-one correspondence with a plurality of subcarrier spacings; perform cross-correlation between each of the plurality of descrambled signals and the second synchronization reference sequence, to obtain a plurality of cross-correlation amplitudes corresponding to the plurality of scrambling sequences; and determine a subcarrier spacing corresponding to a scrambling sequence with a largest cross-correlation amplitude as a subcarrier spacing used by a terminal device. Optionally, the processing module is further configured to determine, based on the determined subcarrier spacing used by the terminal device, a frame structure corresponding to the subcarrier spacing.

With reference to the fourth aspect, in a third possible design of the fourth aspect, a 1^{st} superframe of the uplink signal carries first control information, and the first control information indicates a subcarrier spacing used for transmission of a superframe after the 1^{st} superframe. Optionally, the processing module is further configured to determine, based on the subcarrier spacing, a frame structure corresponding to the subcarrier spacing.

With reference to the fourth aspect, in a fourth possible design of the fourth aspect, uplink synchronization may include frequency offset estimation and frame structure determining, and the frame structure determining includes distinguishing between a location of the synchronization sequence and a location of the data frame. The processing module may be further configured to perform cross-correlation based on a second reference sequence and the received uplink signal. A cross-correlation amplitude location may be used to determine the location of the synchronization sequence and the location of the data frame.

With reference to the third aspect and the fourth aspect, the following provides some possible designs:

In a possible design, a subcarrier spacing used to generate the uplink signal is 60 kHz, a length of the first duration is 40 ms, a length of the second duration is 60 ms, the data frame includes six radio frames, and a length of each radio frame is 10 ms.

When the subcarrier spacing used to generate the uplink signal may be 60 kHz, the length of the first duration is 40 ms, the length of the second duration is 60 ms, the data frame includes the six radio frames, and the length of each radio frame is 10 ms, in a possible design, the first sequence and the second sequence each are a Golay sequence whose length is 64, N=37, N1=32, and N2=5. Optionally, the synchronization reference sequence includes a 32 nd first sequence and five second sequences.

In another possible design, the first sequence and the second sequence each are an M-sequence whose length is 63, and N=38.

In a possible design, a subcarrier spacing used to generate the uplink signal may be 15 kHz, a length of the first duration is 20 ms, a length of the second duration is 80 ms, the data frame includes two radio frames, and a length of each radio frame is 40 ms.

When the subcarrier spacing used to generate the uplink signal may be 15 kHz, the length of the first duration is 20 ms, the length of the second duration is 80 ms, the data frame includes the two radio frames, and the length of each radio frame is 40 ms, in a possible design, the first sequence and the second sequence each are a Golay sequence whose length is 16, and N=18; or the first sequence is an M-sequence whose length is 15, and N=20.

In a possible design, the first sequence and the second sequence each are an M-sequence whose length is 15, and N=20.

In a possible design, a subcarrier spacing used to generate the uplink signal is 30 kHz, a length of the first duration is 40 ms, a length of the second duration is 60 ms, the data frame includes three radio frames, and a length of each radio frame is 20 ms.

When the subcarrier spacing used to generate the uplink signal may be 30 kHz, the length of the first duration is 40 ms, the length of the second duration is 60 ms, the data frame includes the three radio frames, and the length of each radio frame is 20 ms, in a possible design, the first sequence and the second sequence each are a Golay sequence whose length is 32, and N=37. In another possible design, the first sequence and the second sequence each are an M-sequence whose length is 31, and N=38.

In a possible design, the data frame in the superframe of the uplink signal includes one or more radio frames, a first radio frame in the one or more radio frames carries second control information, and the first radio frame may be a 1^{st} radio frame in the one or more radio frames. The second control information indicates a quantity of times of repeated transmission of the superframe. A satellite link budget can be compensated by repeatedly transmitting the superframe, and reliability of data transmission can be improved.

In a possible design, a first frequency hopping mode is used for transmission between a plurality of superframes to implement transmission of the uplink signal, in other words, the first frequency hopping mode is used for transmission between the plurality of superframes during transmission of the uplink signal.

In a possible design, the synchronization sequence is transmitted in the superframe by using a second frequency hopping mode, and/or the data frame includes one or more radio frames, and the one or more radio frames are transmitted in the superframe by using a third frequency hopping mode. Frequency hopping transmission can resist interference and improve system reliability.

In a possible design, the uplink signal in the foregoing designs is transmitted based on a single carrier.

For beneficial effects of the third aspect and the possible designs of the third aspect, refer to the descriptions corresponding to the first aspect. Details are not described herein again.

For beneficial effects of the fourth aspect and the possible designs of the fourth aspect, refer to the descriptions corresponding to the second aspect. Details are not described herein again.

According to a fifth aspect, an embodiment of this application provides a communication apparatus. The apparatus is applied to a non-terrestrial network NTN. The apparatus has functions of implementing the method according to any one of the first aspect or the possible designs of the first aspect. The communication apparatus includes a communication interface and a processor. The communication interface is used by the apparatus to communicate with another device, for example, receive and send data or a signal. For example, the communication interface may be a transceiver, a circuit, a bus, a module, or a communication interface of another type, and the another device may be a network device or a node. The processor is configured to invoke a group of programs, instructions, or data, to perform the method according to the first aspect or the possible designs. The apparatus may further include a memory, configured to store the programs, the instructions, or the data invoked by the processor. The memory is coupled to the processor. When the processor executes the programs, the instructions or the data stored in the memory, the method according to the first aspect or the possible designs may be implemented.

According to a sixth aspect, an embodiment of this application provides a communication apparatus. The apparatus is applied to a non-terrestrial network NTN. The apparatus has functions of implementing the method according to any one of the second aspect or the possible designs of the second aspect. The communication apparatus includes a communication interface and a processor. The communication interface is used by the apparatus to communicate with another device, for example, receive and send data or a signal. For example, the communication interface may be a transceiver, a circuit, a bus, a module, or a communication interface of another type, and the another device may be a network device or a node. The processor is configured to invoke a group of programs, instructions, or data, to perform the method according to the second aspect or the possible designs. The apparatus may further include a memory, configured to store the programs, the instructions, or the data invoked by the processor. The memory is coupled to the processor. When the processor executes the instructions or the data stored in the memory, the method according to the second aspect or the possible designs may be implemented.

According to a seventh aspect, an embodiment of this application further provides a computer-readable storage medium. The computer-readable storage medium stores computer-readable instructions, and when the computer-readable instructions are run on a computer, the computer is enabled to perform the method according to any one of the first aspect or the possible designs of the first aspect or the method according to any one of the second aspect or the possible designs of the second aspect.

According to an eighth aspect, an embodiment of this application provides a chip system. The chip system includes a processor, and may further include a memory, to implement the method according to any one of the first aspect or the possible designs of the first aspect or the method according to any one of the second aspect or the possible designs of the second aspect. The chip system may include a chip, or may include a chip and another discrete component.

According to a ninth aspect, an embodiment of this application provides a communication system. The system includes a terminal device and a network device. The terminal device may perform the method according to any one of the first aspect or the possible designs of the first aspect, and the network device may perform the method according to any one of the second aspect or the possible designs of the second aspect.

According to a tenth aspect, a computer program product including instructions is provided. When the computer program product runs on a computer, the computer is enabled to perform the method according to any one of the first aspect or the possible designs of the first aspect or the method according to any one of the second aspect or the possible designs of the second aspect.

### BRIEF DESCRIPTION OF THE DRAWINGS

FIG. 1 is a schematic diagram of an architecture of a terrestrial network communication system according to an embodiment of this application;

FIG. 2 is a schematic diagram of an architecture of a non-terrestrial network communication system according to an embodiment of this application;

FIG. 3 is a schematic diagram of an architecture of a 5G satellite communication system according to an embodiment of this application;

FIG. 4 is a schematic flowchart of a narrowband internet of things-based communication method according to an embodiment of this application;

FIG. 5 is a schematic diagram of a frame structure 1 according to an embodiment of this application;

FIG. 6 is a schematic diagram of a structure of a synchronization sequence according to an embodiment of this application;

FIG. 7 is a schematic diagram of a frame structure 2 according to an embodiment of this application;

FIG. 8 is a schematic diagram of a frame structure 3 according to an embodiment of this application;

FIG. 9 is a schematic diagram in which a terminal device performs data transmission by using a scrambling sequence according to an embodiment of this application;

FIG. 10 is a schematic diagram in which a terminal device indicates a subcarrier spacing by using control information according to an embodiment of this application;

FIG. 11 is a schematic diagram of available bandwidth division according to an embodiment of this application;

FIG. 12 is a schematic diagram of inter-superframe frequency hopping according to an embodiment of this application;

FIG. 13 is a schematic diagram of intra-superframe frequency hopping according to an embodiment of this application;

FIG. 14 is a schematic diagram of a process in which a transmit end generates an uplink signal according to an embodiment of this application;

FIG. 15A and FIG. 15B are a schematic diagram of a process in which a receive end processes an uplink signal according to an embodiment of this application;

FIG. 16 is a schematic diagram 1 of a structure of a communication apparatus according to an embodiment of this application; and

FIG. 17 is a schematic diagram 2 of a structure of a communication apparatus according to an embodiment of this application.

### DETAILED DESCRIPTION OF ILLUSTRATIVE EMBODIMENTS

Embodiments of this application provide a narrowband internet of things-based communication method and an apparatus. The method and the apparatus are based on a same technical concept. Because problem-resolving principles of the method and the apparatus are similar, mutual reference may be made to implementations of the apparatus and the method, and repeated descriptions are not described again. In descriptions of embodiments of this application, a term “and/or” describes an association relationship between associated objects and indicates that three relationships may exist. For example, A and/or B may indicate the following three cases: Only A exists, both A and B exist, and only B exists. A character “/” generally indicates an “or” relationship between the associated objects. In this application, “at least one” means one or more, and “a plurality of” means two or more. In addition, it should be understood that, in the descriptions of this application, terms such as “first”, “second”, and “third” are merely used for distinguishing and description, but should not be understood as an indication or implication of relative importance, or should not be understood as an indication or implication of a sequence.

The narrowband internet of things-based communication method provided in embodiments of this application may be applied to a 4th generation (4G) communication system, for example, a long term evolution (LTE) system; or may be applied to a 5th generation (5G) communication system, for example, 5G new radio (NR); or may be applied to various future communication systems, for example, a 6th generation (6G) communication system. The method provided in the embodiments of this application may be applied to a terrestrial network communication system, or may be applied to a non-terrestrial network (NTN) communication system.

The following describes embodiments of this application in detail with reference to the accompanying drawings.

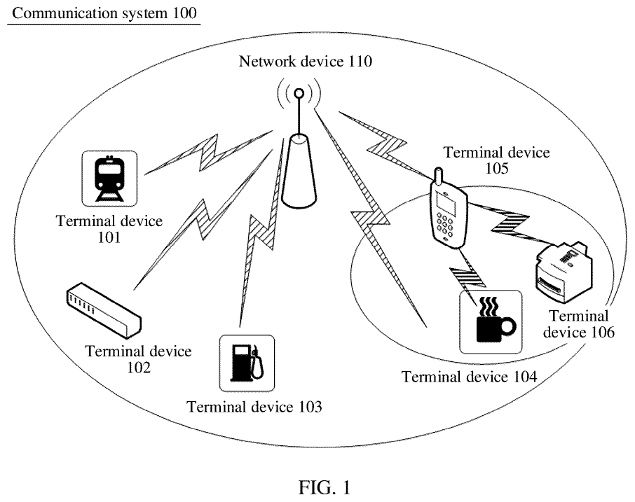

FIG. 1 shows a possible architecture of a terrestrial network communication system to which a narrowband internet of things-based communication method is applicable according to an embodiment of this application. A communication system boo may include a network device no and a terminal device 101 to a terminal device 106. It should be understood that the communication system boo may include more or fewer network devices or terminal devices. The network device or the terminal device may be hardware, or may be software obtained through function division, or may be a combination thereof. In addition, the terminal device 104 to the terminal device 106 may also form a communication system. For example, the terminal device 105 may send downlink data to the terminal device 104 or the terminal device 106. The network device and the terminal device may communicate with each other through another device or network element. The network device 110 may send downlink data to the terminal device 101 to the terminal device 106, or may receive uplink data sent by the terminal device 101 to the terminal device 106. Certainly, the terminal device 101 to the terminal device 106 may alternatively send uplink data to the network device no, or may receive downlink data sent by the network device no.

The network device no is a node in a radio access network (RAN), and may also be referred to as a base station or a RAN node (or device). Currently, some examples of the access network device no are: a gNB/NR-NB, a transmission reception point (transmission reception point, TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a wireless fidelity (Wi-Fi) access point (AP), a network device in a 5G communication system, and a network device in a future possible communication system. The network device 110 may alternatively be another device having a network device function. For example, the network device no may alternatively be a device having a network device function in D2D communication. The network device no may alternatively be a network device in a future possible communication system.

The terminal device 101 to the terminal device 106 each may also be referred to as user equipment (UE), a mobile station (MS), a mobile terminal (MT), or the like, and each are a device that provides a user with voice or data connectivity, or each may be an internet of things device. For example, the terminal device 101 to the terminal device 106 each include a handheld device, an in-vehicle device, or the like that has a wireless connection function. Currently, the terminal device 101 to the terminal device 106 each may be a mobile phone, a tablet computer, a notebook computer, a palmtop computer, a mobile internet device (MID), a wearable device (for example, a smartwatch, a smart band, or a pedometer), an in-vehicle device (for example, an automobile, a bicycle, an electric vehicle, an aircraft, a ship, a train, or a high-speed train), a virtual reality (VR) device, an augmented reality (AR) device, a wireless terminal in industrial control, a smart home device (for example, a refrigerator, a television, an air conditioner, or an electricity meter), an intelligent robot, a workshop device, a wireless terminal in self driving, a wireless terminal in remote medical surgery, a wireless terminal in a smart grid, a wireless terminal in transportation safety, a wireless terminal in a smart city, a wireless terminal in a smart home, a flight device (for example, an intelligent robot, a hot balloon, an unmanned aerial vehicle, or an aircraft), or the like. The terminal device 101 to the terminal device 106 each may alternatively be another device having a terminal function. For example, the terminal device 101 to the terminal device 106 each may alternatively be a device having a terminal function in D2D communication.

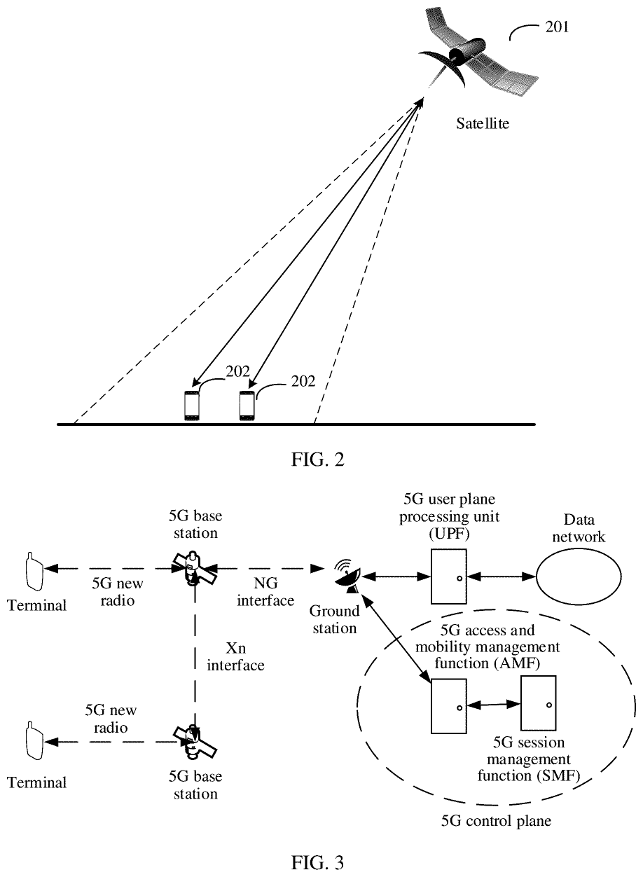

Based on the descriptions of the architecture of the terrestrial network communication system shown in FIG. 1, the narrowband internet of things-based communication method provided in the embodiment of this application may be applicable to an NTN communication system. In this embodiment of this application, for example, NTN communication is satellite communication, in other words, an NTN communication system is a satellite system. As shown in FIG. 2, the NTN communication system includes a satellite 201 and terminal devices 202. For an explanation of the terminal devices 202, refer to the related descriptions of the terminal device 101 to the terminal device 106. The satellite 201 may also be referred to as a high-altitude platform, a high-altitude aircraft, or a satellite base station. When the NTN communication system is associated with the terrestrial network communication system, the satellite 201 may be considered as one or more network devices in the architecture of the terrestrial network communication system. The satellite 201 provides a communication service for the terminal devices 202, and the satellite 201 may be further connected to a core network device. For a structure and a function of a network device no, refer to the foregoing descriptions of the network device no. For a manner of communication between the satellite 201 and the terminal devices 202, refer to the descriptions in FIG. 1. Details are not described herein again.

5G is used as an example. An architecture of a 5G satellite communication system is shown in FIG. 3. A terrestrial terminal device accesses a network through 5G new radio. A 5G base station is deployed on a satellite and is connected to a terrestrial core network through a radio link. In addition, there are radio links between satellites to implement signaling exchange and user data transmission between base stations. Devices and interfaces in FIG. 3 are described as follows.

5G core network: The 5G core network provides services such as user access control, mobility management, session management, user security authentication, and accounting. The 5G core network includes a plurality of function units, and can be divided into a control-plane functional entity and a data-plane functional entity. An access and mobility management function (AMF) unit is responsible for user access management, security authentication, and mobility management. A user plane function (UPF) unit is responsible for managing functions such as user plane data transmission and traffic statistics collection.

Ground station: The ground station is responsible for forwarding signaling and service data between a satellite base station and a 5G core network.

5G new radio: The 5G new radio is a radio link between a terminal and a base station.

Xn interface: The Xn interface is an interface between a 5G base station and a base station, and is mainly used for signaling exchange such as handover.

NG interface: The NG interface is an interface between a 5G base station and a 5G core network, and is mainly used for exchange of signaling such as NAS signaling of a core network and user service data exchange.

The network device in the terrestrial network communication system and the satellite in the NTN communication system are all considered as network devices. An apparatus configured to implement a function of a network device may be a network device, or may be an apparatus, for example, a chip system, that can support the network device in implementing the function, and the apparatus may be installed in the network device. When the technical solutions provided in embodiments of this application are described below, an example in which the apparatus configured to implement a function of a network device is a satellite is used to describe the technical solutions provided in the embodiments of this application. It may be understood that, when the method provided in embodiments of this application is applied to the terrestrial network communication system, an action performed by the satellite may be performed by a base station or a network device.

In embodiments of this application, an apparatus configured to implement a function of a terminal device may be a terminal device, or may be an apparatus, for example, a chip system, that can support the terminal device in implementing the function, and the apparatus may be installed in the terminal device. In embodiments of this application, the chip system may include a chip, or may include a chip and another discrete component. In the technical solutions provided in embodiments of this application, an example in which the apparatus configured to implement a function of a terminal device is the terminal device is used to describe the technical solutions provided in the embodiments of this application.

A narrowband internet of things system mainly relies on wireless access, and can provide a service only in a scenario in which a communication network including a base station exists. However, construction of a terrestrial base station and network is limited by many conditions. For example, it is difficult to build base stations in areas with complex terrains and special areas such as deserts and oceans, and the terrestrial network is vulnerable to the impact of ground weather conditions and damage in the case of natural disasters. These factors greatly limit further development of the narrowband internet of things system. Satellite communication has advantages of wide coverage and not restricted by geographical environment, which can be used as an effective supplement to ground communication. The satellite communication has been widely used in a plurality of fields such as aviation. Introduction of the satellite communication into a future sixth generation (6G) mobile network can provide communication services for areas that are affected by the environment and cannot be covered by the terrestrial network; can also provide more stable and better communication services for users on transportation means such as aircraft, ships, and motor vehicles; can also provide emergency communication in the case of natural disasters and large-scale sports events; and can also provide private networks for government and enterprise users to meet specific service requirements. The satellite communication is introduced into the narrowband internet of things system for supplement and extension of the terrestrial internet of things. This can effectively overcome disadvantages of a conventional terrestrial network and provide the following advantages: coverage is wide, a plurality of satellites can form a constellation to achieve global coverage, and a terrestrial terminal can be deployed at any time without being restricted by the environment; satellites are deployed in the high air and are less affected by weather and geographical conditions, and the system can work continuously; and the satellite communication does not depend on the terrestrial network, and when a natural disaster occurs or the terrestrial network is damaged, the satellite communication can work properly, and the entire system is highly reliable.

A transmission distance of a terrestrial communication-based narrowband internet of things system is relatively short, and is generally about 15 kilometers (km). In addition, a terminal and a base station need to remain relatively static, and a frequency offset that can be tolerated by the system is relatively small. However, in a satellite communication system, due to an orbit height, a transmission distance between a satellite and a terminal is relatively long, and a path loss is relatively large. In addition, high-speed movement of the satellite causes a large Doppler frequency shift at a receive end, which brings great challenges to synchronization and information receiving at the receive end. In the terrestrial communication-based narrowband internet of things system, a synchronization signal is usually required to be transmitted in a downlink to achieve synchronization between a terminal and a base station. However, in a satellite-based narrowband internet of things system, if a synchronization method in terrestrial communication is used, a satellite needs to deliver an ephemeris to achieve synchronization with a terminal. However, because a bandwidth of the terminal is narrow and a link budget is poor, it takes a long transmission time for the satellite to deliver the ephemeris, which is not conducive to synchronization between the terminal and the satellite. In addition, the terminal usually needs a relatively long time for synchronization and decoding, and overheads are high, which brings adverse impact on a low-power design of the terminal. Therefore, the terrestrial communication-based narrowband internet of things system cannot be directly applied to the satellite communication.

Based on this, an embodiment of this application provides a narrowband internet of things-based communication method, to apply a narrowband internet of things technology to NTN communication, for example, to the satellite communication.

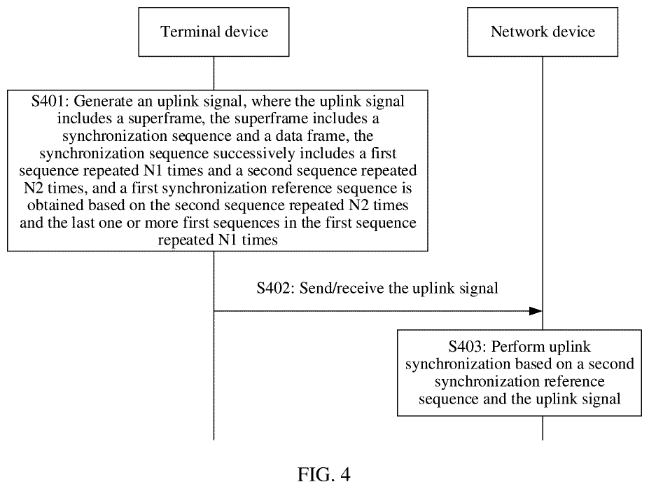

As shown in FIG. 4, a procedure of the narrowband internet of things-based communication method in this embodiment of this application is described as follows. The method may be performed by a terminal device, or may be performed by a processing chip in the terminal device. This is not limited in this application.

S401: The terminal device generates an uplink signal.

A frame structure of the uplink signal includes a superframe. One superframe includes a synchronization sequence and a data frame. The synchronization sequence is located in first duration of the superframe. The data frame is located in second duration of the superframe. The first duration of the superframe is before the second duration. The synchronization sequence is formed by repeating a sequence of a type N times. The synchronization sequence successively includes a first sequence repeated N1 times and a second sequence repeated N2 times. The second sequence is obtained by multiplying the first sequence by −1. Alternatively, it may be considered that the first sequence is positive and the second sequence is negative, or a symbol of the second sequence is opposite to a symbol of the first sequence, or the first sequence and the second sequence are in a positive-negative relationship. For example, the first sequence is a, and the second sequence is −a. A part of sequences of the synchronization sequence are used as a synchronization reference sequence, which may be denoted as a first synchronization reference sequence. The first synchronization reference sequence may be obtained based on the second sequence repeated N2 times and one or more first sequences that are sorted from back to front in the first sequence repeated N1 times. In other words, the first synchronization reference sequence includes the second sequence repeated N2 times and the one or more first sequences connected to the second sequence repeated N2 times. N, N1, and N2 are all positive integers, N is greater than 2, and N2 is greater than 1. Both the first duration and the second duration are time lengths. The superframe is a period of duration. The period of duration includes the first duration, and the first duration is followed by the second duration.

The synchronization reference sequence may be an auxiliary sequence known by a receive end for a synchronization signal function. The receive end may perform cross-correlation between the pre-stored synchronization reference sequence and the received uplink signal. A cross-correlation amplitude location may be used to determine a joint point of the synchronization sequence and the data frame, so as to distinguish between a location of the synchronization sequence and a location of the data frame in the superframe of the received uplink signal. The first synchronization reference sequence in the uplink signal undergoes noise interference of some channels in a transmission process, and the synchronization reference sequence used by the receive end for synchronization may be a locally pre-stored sequence. It may be understood that a second reference sequence and a first reference sequence are reference sequences in a same format, the first reference sequence is a sequence included in the uplink signal, and the second reference sequence is a sequence locally stored by the receive end. Therefore, for ease of distinguishing, the first synchronization reference sequence and a second synchronization reference sequence are used for distinguishing in this embodiment of this application. Herein, “same format” means that the first reference sequence is the last X sequences in the synchronization sequence, and the second reference sequence is also the last X sequences in the synchronization sequence. The receive end generally locally stores the synchronization reference sequence, and may further store the synchronization sequence, or may store a correspondence between the synchronization sequence and the synchronization reference sequence. The receive end may perform synchronization based on the locally stored synchronization sequence, that is, the receive end performs synchronization based on the synchronization reference sequence including the last X sequences in the synchronization sequence. Optionally, frame structures in a plurality of subcarrier spacings may be different, that is, synchronization reference sequences in different subcarrier spacings are different. In this case, the receive end may pre-store second synchronization reference sequences respectively corresponding to the plurality of subcarrier spacings.

S402: The terminal device sends the uplink signal to a network device, and the network device receives the uplink signal.

S403: The network device performs uplink synchronization based on the second synchronization reference sequence and the uplink signal.

The uplink synchronization can ensure data receiving correctness and reliability. The uplink synchronization may include frequency offset estimation and frame structure determining, and the frame structure determining includes distinguishing between the location of the synchronization sequence and the location of the data frame.

In the embodiment in FIG. 4, the network device does not need to deliver a synchronization signal to the terminal device, and the terminal device may directly send the uplink signal to the network device. In addition, using a frame structure design of the uplink signal can achieve synchronization after the network device receives the uplink signal. The terminal device uses an asynchronous communication mode, so that transmission overheads of delivering an ephemeris by the network device can be effectively saved, time overheads caused by synchronization performed before data transmission can be reduced, and power consumption and overheads caused by synchronization and decoding on the terminal device can be reduced.

The following describes some possible implementations of the embodiment in FIG. 4.

The frame structure in this embodiment of this application is first described.

The terminal device and the network device may negotiate a frame structure of a physical frame or specify a frame structure of a physical frame in a protocol. The following describes several examples of the frame structure.

Frame structure 1:

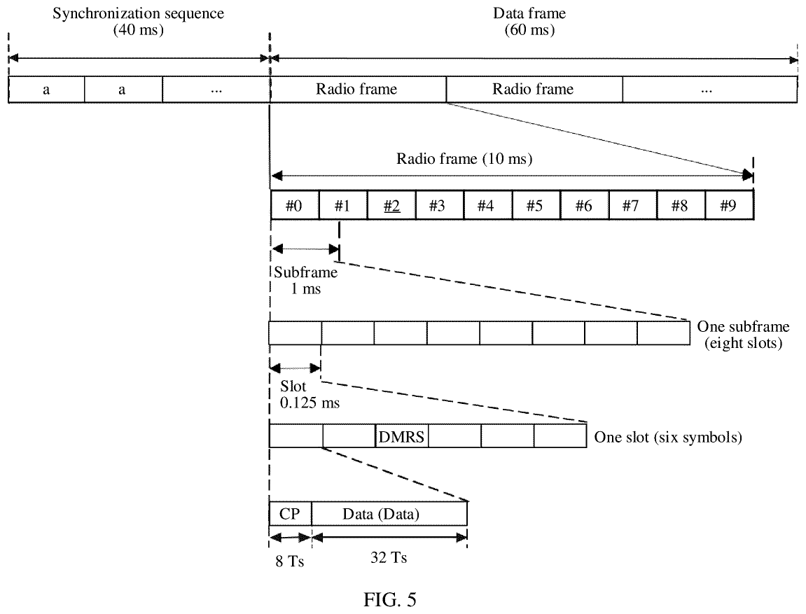

The frame structure 1 is shown in FIG. 5. FIG. 5 shows a structure of one superframe, and one superframe is one period. A length of one superframe is 100 milliseconds (ms), and every 100 ms is one period. One superframe includes a synchronization sequence and a data frame. A length of the synchronization sequence and a length of the data frame are set to 40 ms and 60 ms respectively. In one superframe, each data frame includes six radio frames, and a length of each radio frame is 10 ms. Each radio frame includes 10 subframes, each subframe includes eight slots, each slot includes six symbols, and a demodulation reference signal (DMRS) is located in a 3^{rd} symbol. A symbol length is 32 Ts, and a cyclic prefix (CP) length is 8 Ts. Herein, Ts is a sampling time interval.

It may be understood that the length of the synchronization sequence and the length of the data frame may be adjusted according to an actual situation. In the frame structure 1 shown in FIG. 5, using the 40 ms synchronization sequence can ensure that a transmit end and a receive end complete synchronization within a proper overhead range without greatly affecting data transmission of a subsequent radio frame.

Based on the frame structure 1 shown in FIG. 5, the following describes some optional implementations of the synchronization sequence.

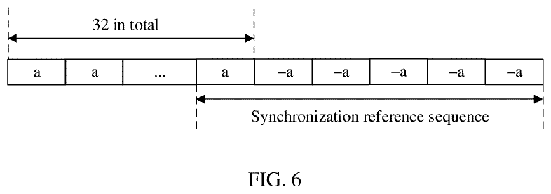

The synchronization sequence may be in a structure shown in FIG. 6. The synchronization sequence uses a Golay sequence whose length may be 64, and the synchronization sequence is formed by repeating the Golay sequence 37 times. The first 32 Golay sequences are positive and each may be denoted as a, and the last five Golay sequences are negative and each may be denoted as −a. Herein, −a is obtained by multiplying a by −1.

Alternatively, the synchronization sequence may use an M-sequence whose length is 63, and the synchronization sequence is formed by repeating the M-sequence 38 times.

Based on the synchronization sequence, the first synchronization reference sequence may include one or more a and a plurality of −a in the synchronization sequence. For example, as shown in the example in FIG. 6, the first synchronization reference sequence may be the last six Golay sequences in the synchronization sequence, including one a and five −a. It may be understood that a quantity of a and a quantity of −a in the synchronization sequence may be flexibly adjusted according to a system requirement.

The frame structure 1 shown in FIG. 5 is applicable to a scenario in which a subcarrier spacing is 60 kHz, and a bandwidth in the scenario is 60 kHz.

Frame structure 2:

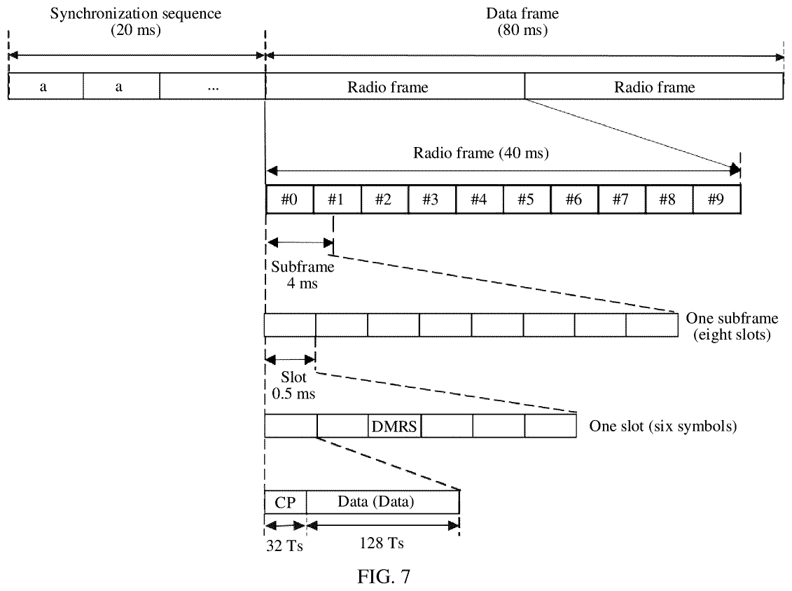

The frame structure 2 is shown in FIG. 7. FIG. 7 shows a structure of one superframe, and one superframe is one period. A length of one superframe is 100 milliseconds (ms), and every 100 ms is one period. One superframe includes a synchronization sequence and a data frame. A length of the synchronization sequence and a length of the data frame are set to 20 ms and 80 ms respectively. In one superframe, each data frame includes two radio frames, and a length of each radio frame is 40 ms. Each radio frame includes 10 subframes, each subframe includes eight slots, each slot includes six symbols, and a DMRS is located in a 3^{rd} symbol. A symbol length may be 128 Ts, and a CP length may be 32 Ts.

It may be understood that the length of the synchronization sequence and the length of the data frame may be adjusted according to an actual situation. In the frame structure 2 shown in FIG. 7, using the 20 ms synchronization sequence can ensure that a transmit end and a receive end complete synchronization within a proper overhead range without greatly affecting data transmission of a subsequent radio frame.

Based on the frame structure 2 shown in FIG. 7, the following describes some optional implementations of the synchronization sequence.

The synchronization sequence may use a Golay sequence whose length is 16, and the synchronization sequence is formed by repeating the Golay sequence 18 times.

Alternatively, the synchronization sequence may use an M-sequence whose length is 15, and the synchronization sequence is formed by repeating the M-sequence 20 times.

It may be understood that a quantity of a and a quantity of −a in the synchronization sequence may be flexibly adjusted according to a system requirement.

The frame structure 2 shown in FIG. 7 is applicable to a scenario in which a subcarrier spacing is 15 kHz, and a bandwidth in the scenario is 15 kHz.

Frame structure 3:

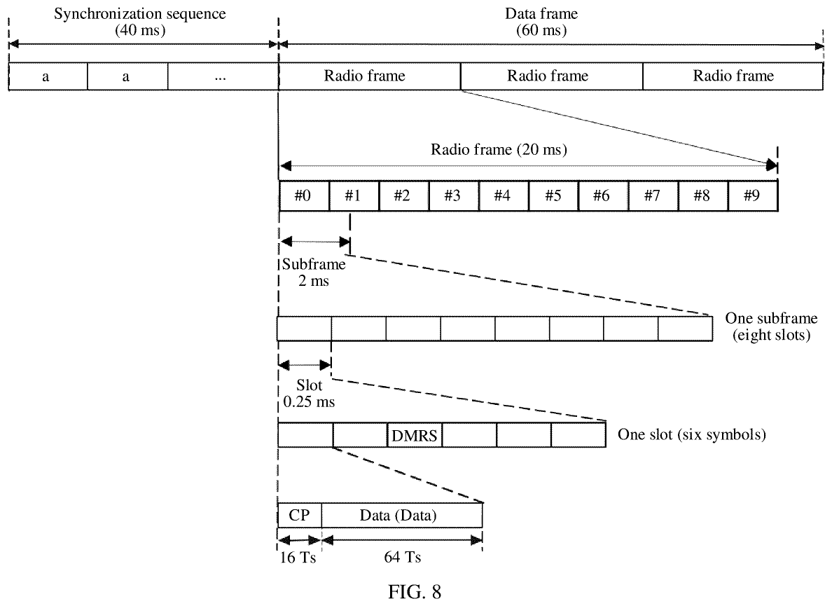

The frame structure 3 is shown in FIG. 8. FIG. 8 shows a structure of one superframe, and one superframe is one period. A length of one superframe is 100 milliseconds (ms), and every 100 ms is one period. One superframe includes a synchronization sequence and a data frame. A length of the synchronization sequence and a length of the data frame are set to 40 ms and 60 ms respectively. In one superframe, each data frame includes three radio frames, and a length of each radio frame is 20 ms. Each radio frame includes 10 subframes, each subframe includes eight slots, each slot includes six symbols, and a DMRS is located in a 3rd symbol. A symbol length may be 64 Ts, and a CP length may be 16 Ts.

It may be understood that the length of the synchronization sequence and the length of the data frame may be adjusted according to an actual situation. In the frame structure 3 shown in FIG. 8, using the 40 ms synchronization sequence can ensure that a transmit end and a receive end complete synchronization within a proper overhead range without greatly affecting data transmission of a subsequent radio frame.

Based on the frame structure 3 shown in FIG. 8, the following describes some optional implementations of the synchronization sequence.

The synchronization sequence may use a Golay sequence whose length is 32, and the synchronization sequence is formed by repeating the Golay sequence 37 times.

Alternatively, the synchronization sequence may use an M-sequence whose length is 31, and the synchronization sequence is formed by repeating the M-sequence 38 times.

It may be understood that a quantity of a and a quantity of −a in the synchronization sequence may be flexibly adjusted according to a system requirement.

The frame structure 3 shown in FIG. 8 is applicable to a scenario in which a subcarrier spacing is 30 kHz, and a bandwidth in the scenario is 30 kHz.

In the frame structure provided in this embodiment of this application, the synchronization reference sequence may be used by a receive end to perform cross-correlation with a synchronization sequence in a received signal when the receive end receives the signal, so as to implement synchronization. In this embodiment, because there are a plurality of −a in the synchronization reference sequence, when cross-correlation is performed, there is a relatively long reduction interval during window sliding. This can implement performance loss compensation and facilitate synchronization.

The frame structure 1 to the frame structure 3 are merely examples of the frame structure. The frame structure complies with the feature descriptions of the frame structure in S401. Optionally, the frame structure may be further appropriately changed.

It can be learned from the foregoing examples of the frame structure that different subcarrier spacings may correspond to different frame structures. The frame structure includes a design of the synchronization sequence. During actual application, when using different subcarrier spacings, the terminal device may use frame structures corresponding to the subcarrier spacings. For example, when a subcarrier spacing of 60 kHz is used, the uplink signal is generated by using the frame structure 1. For another example, when a subcarrier spacing of 15 kHz is used, the uplink signal is generated by using the frame structure 2 shown in FIG. 7. For example, when a subcarrier spacing of 30 kHz is used, the uplink signal is generated by using the frame structure 3 shown in FIG. 8.

As shown in FIG. 4, the terminal device and the network device are used as an example to describe the embodiment of this application. The embodiment of this application may be applied to any signal interaction and transmission between the transmit end and the receive end. For example, the transmit end sends a signal to the receive end, and the receive end receives the signal from the transmit end and performs synchronization. When the transmit end is the terminal device, the receive end is the network device, and the network device may be, for example, a device such as a satellite. When the transmit end is the network device, the receive end may be the terminal device, for example, an electronic device such as UE.

An example in which the transmit end and the receive end perform signal interaction is used below for description.

Before signal transmission, the transmit end and the receive end may determine, through negotiation, a subcarrier spacing and a frame structure that are used for signal transmission. In this way, after receiving a signal, the receive end performs synchronization based on a synchronization reference sequence in the frame structure. The subcarrier spacing and the frame structure that are used by the transmit end may be determined in advance, or may be specified in a protocol, or may be determined through negotiation with the receive end. Alternatively, there may be a plurality of optional subcarrier spacings for the transmit end. For example, there are subcarrier spacings of 15 kHz, 30 kHz, and 60 kHz for the transmit end for selection. The transmit end may select any one of the plurality of subcarrier spacings, and send a signal based on the selected subcarrier spacing. After receiving the signal, the receive end first determines a subcarrier spacing used by the transmit end, and determines a frame structure of the transmit end. The following describes an optional method for performing processing after the receive end receives a signal. An example in which the receive end is the network device is used. The network device receives the uplink signal sent by the terminal device. It may be understood that the following described method may be applied to a scenario in which the receive end is the terminal device.

The network device may obtain a set of subcarrier spacings that may be used by the terminal device and related information in advance. The related information may be a frame structure corresponding to a subcarrier spacing. The network device may determine the foregoing information through negotiation with the terminal device, or may determine the foregoing information through protocol specification.

In an optional manner 1, the network device may locally pre-store a plurality of second synchronization reference sequences; after receiving the uplink signal, the network device performs cross-correlation between the uplink signal and each of the plurality of second synchronization reference sequences, to obtain cross-correlation amplitudes corresponding to the plurality of second synchronization reference sequences, where the plurality of second synchronization reference sequences are in a one-to-one correspondence with a plurality of subcarrier spacings; and the network device may determine a subcarrier spacing corresponding to a second synchronization reference sequence with a largest cross-correlation amplitude as a subcarrier spacing used by the terminal device.

Optionally, after receiving the uplink signal, the network device may perform blind detection and a synchronization operation on the uplink signal, and then perform cross-correlation between the uplink signal and each of the plurality of synchronization reference sequences.

In an optional manner 2, after receiving the uplink signal, the network device descrambles the uplink signal by using a plurality of scrambling sequences, to obtain a plurality of descrambled signals corresponding to the plurality of scrambling sequences, where the plurality of scrambling sequences are in a one-to-one correspondence with a plurality of subcarrier spacings; the network device performs cross-correlation between each of the plurality of descrambled signals and the second synchronization reference sequence, to obtain a plurality of cross-correlation amplitudes corresponding to the plurality of scrambling sequences; and the network device may determine a subcarrier spacing corresponding to a scrambling sequence with a largest cross-correlation amplitude as a subcarrier spacing used by the terminal device.

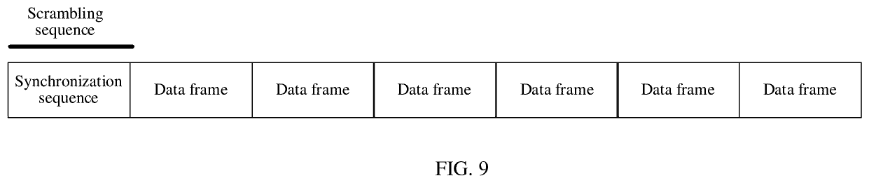

Correspondingly, when sending the uplink signal, the terminal device may transmit data by using any subcarrier spacing. Each subcarrier spacing has a corresponding scrambling sequence. As shown in FIG. 9, the terminal device selects a subcarrier spacing to transmit data, and scrambles the synchronization sequence by using a scrambling sequence, where the used scrambling sequence is a scrambling sequence corresponding to the selected subcarrier spacing.

For example, a subcarrier spacing of 30 kHz corresponds to a scrambling sequence a, and a subcarrier spacing of 60 kHz corresponds to a scrambling sequence b. When the terminal device transmits the uplink signal by using the subcarrier spacing of 30 kHz, the terminal device scrambles the synchronization sequence by using the scrambling sequence a. The network device obtains scrambling sequences respectively corresponding to the subcarrier spacings of 30 kHz and 60 kHz in advance. After receiving the uplink signal, the network device descrambles the uplink signal by separately using the scrambling sequence a and the scrambling sequence b, to obtain two descrambled signals, which are denoted as a descrambled signal a and a descrambled signal b. The descrambled signal a corresponds to the scrambling sequence a, and the descrambled signal b corresponds to the scrambling sequence b. The network device performs cross-correlation between each of the two descrambled signals and the second synchronization reference sequence, to obtain two cross-correlation amplitudes. A cross-correlation amplitude corresponding to the descrambled signal a is greater than a cross-correlation amplitude corresponding to the descrambled signal b. Therefore, the network device may determine the subcarrier spacing based on the descrambled signal a. Specifically, the descrambled signal a corresponds to the scrambling sequence a, and the scrambling sequence a corresponds to 30 kHz. The network device may determine that the terminal device uses the subcarrier spacing of 30 kHz.

In an optional manner 3, the terminal device carries control information in a radio frame, where the control information indicates a subcarrier spacing.

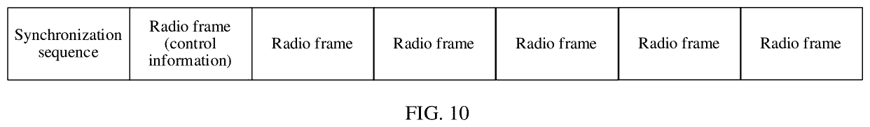

For example, as shown in FIG. 10, when the terminal device sends the uplink signal, a 1^{st} superframe may be sent by using a specified subcarrier spacing, for example, by using a subcarrier spacing of 60 kHz. Control information is carried in a radio frame included in a data frame in the 1^{st} superframe. For example, the control information may be carried in a 1^{st} radio frame in the 1^{st} superframe. The control information indicates a subcarrier spacing used in subsequent superframe transmission.

For example, the control information is included in the 1^{st} radio frame. The control information may indicate one or more parameters. In the embodiment shown in FIG. 10, the control information indicates the subcarrier spacing used in subsequent superframe transmission. Optionally, the control information may use 2 bits to indicate the subcarrier spacing used in subsequent superframe transmission. For example, there are subcarrier spacings of 15 kHz, 30 kHz, and 60 kHz. Herein, ‘00’ may indicate the subcarrier spacing of 15 kHz, ‘01’ may indicate the subcarrier spacing of 30 kHz, and ‘11’ may indicate the subcarrier spacing of 60 kHz.

As shown in Table 1, the control information indicates an example of the subcarrier spacing used in subsequent superframe transmission.

TABLE 1

| | Quantity |
|---|---|
| Parameter | of bits |
| Subcarrier spacing used in subsequent superframe | 2 bits |
| transmission | |

After determining the subcarrier spacing used by the terminal device, the network device may determine, based on a correspondence between a subcarrier spacing and a frame structure used by the terminal device, so as to parse the uplink signal by using the frame structure.

To improve data reliability, a same superframe may be repeatedly transmitted a plurality of times in a manner of repeatedly transmitting a superframe. In this embodiment of this application, during application to satellite communication, because a satellite communication link budget is relatively poor, a quantity of times of repeated transmission of a superframe may be designed. The quantity of times of repeated transmission of the superframe may be indicated by using the control information. Optionally, 8 bits may be used in the control information to indicate the quantity of times of repeated transmission of the superframe. Based on different data types, the superframe may be used to transmit a physical uplink control channel (PUCCH) or a physical uplink shared channel (PUSCH). The control information separately indicates a quantity of times of repeated transmission of the PUCCH or the PUSCH.

As shown in Table 2, the control information indicates an example of a quantity of times of repeated transmission of the superframe.

TABLE 2

| | Quantity |
|---|---|
| Parameter | of bits |
| Quantity of times of repeated transmission of the PUCCH | 8 bits |
| Quantity of times of repeated transmission of the PUSCH | 8 bits |

Optionally, to compensate for a link budget, a basic quantity of times of repeated transmission may be set. The quantity of times of repeated transmission indicated in the control information is accumulated based on a basic quantity of times of repeated transmission, and an accumulated value does not exceed a maximum quantity of times of repeated transmission allowed by a system. For example, the basic quantity of times of repeated transmission is 4, and the quantity of times of repeated transmission indicated by the control information is accumulated based on the four times of repeated transmission. The maximum quantity of times of repeated transmission allowed by the system may be, for example, 259.

Based on the foregoing descriptions of the control information, it is assumed that the parameter indicated by the control information includes the subcarrier spacing used in subsequent superframe transmission, the quantity of times of repeated transmission of the PUCCH, and the quantity of times of repeated transmission of the PUSCH, and the parameter indicated by the control information may further include a parameter of another type. The following uses an example to describe the parameter indicated by the control information. As shown in Table 3, the control information occupies 40 bits in total. Herein, 13 bits indicate a UE parameter; 3 bits indicate a modulation and coding scheme (MCS); 13 bits indicate a UE parameter; 7 bits indicate a quantity of times of repeated transmission of the PUCCH; 7 bits indicate a quantity of times of repeated transmission of the PUSCH; 8 bits indicate a cyclic redundancy check (CRC); and 2 bits indicate a subcarrier spacing used in subsequent superframe transmission.

TABLE 3

| | Quantity |
|---|---|
| Parameter | of bits |
| UE parameter | 13 bits |
| MCS | 3 bits |
| Quantity of times of repeated transmission of the PUCCH | 7 bits |
| Quantity of times of repeated transmission of the PUSCH | 7 bits |
| CRC | 8 bits |
| Subcarrier spacing used in subsequent superframe | 2 bits |
| transmission | |
| Total quantity | 40 bits |

In a possible design, in this embodiment of this application, a frequency hopping transmission mode may be further used for transmission. For example, an inter-superframe frequency hopping transmission mode may be used. For another example, an intra-superframe frequency hopping transmission mode may be further used. Frequency hopping transmission can resist interference and improve system reliability.

In the inter-superframe frequency hopping transmission mode, a first frequency hopping mode may be used for transmission between a plurality of superframes to implement transmission of the uplink signal. It may alternatively be considered that the uplink signal is transmitted between superframes by using the first frequency hopping mode, in other words, the first frequency hopping mode is used for transmission between the plurality of superframes during transmission of the uplink signal. The transmit end may sequentially send the superframe on a plurality of subcarriers. For example, a signal is sequentially sent on a plurality of subcarriers in a fixed frequency hopping mode. The following uses an example to describe the inter-superframe frequency hopping transmission mode with reference to a specific scenario.

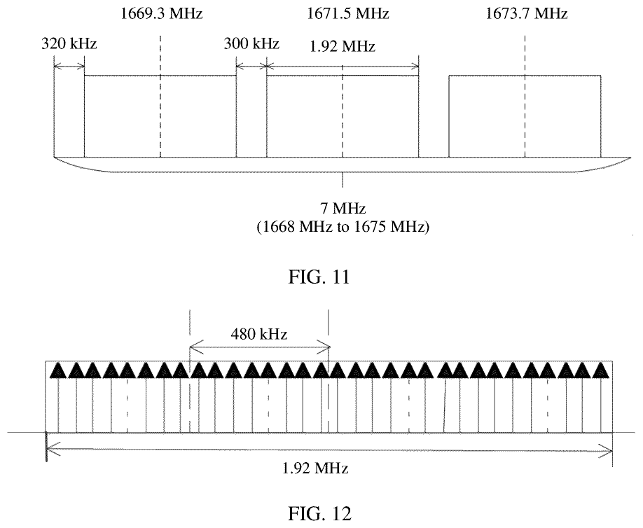

As shown in FIG. 11, it is assumed that an available frequency band is a 7 MHz bandwidth from 1.668 GHz to 1.675 GHz, and a baseband sampling rate is 1.92 MHz. The bandwidth is divided into three sub-bands with a bandwidth of 1.92 MHz, center frequencies are respectively 1.6993 GHz, 1.6715 GHz, and 1.6737 GHz, and a 60 kHz sub-channel within the bandwidth of 1.92 MHz is allocated to a single terminal. To resist interference, when the single terminal transmits a signal in the bandwidth of 1.92 MHz, four frequency hopping frequencies (that is, four subcarriers) are selected, and the signal is sequentially sent on the four subcarriers, so that the signal can be prevented from being overwhelmed by a single frequency. FIG. 12 shows an example of frequency hopping frequency selection. In the figure, dashed-line subcarriers are selected frequencies, and are respectively in-band indexes {4,12, 20, 28}. The terminal sends a signal on four subcarriers corresponding to {4, 12, 20, 28}.

A frequency hopping frequency and a frequency hopping mode may be flexibly selected, and the network device may obtain and store the frequency hopping frequency and the frequency hopping mode in advance. For example, the network device may negotiate the frequency hopping frequency and the frequency hopping mode with the terminal device in advance, or specify the frequency hopping frequency and the frequency hopping mode in a protocol.

In the intra-superframe frequency hopping transmission mode, a synchronization sequence is sent through frequency hopping on a plurality of subcarriers in a superframe; and/or a radio frame in a data frame is sent through frequency hopping on a plurality of subcarriers in the superframe. The following uses an example to describe the intra-superframe frequency hopping transmission mode with reference to a specific scenario.

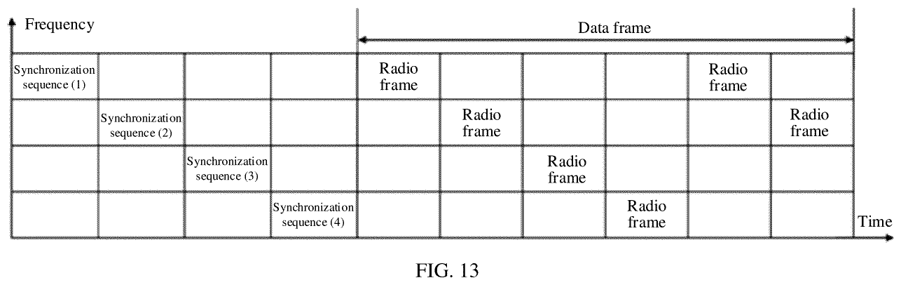

As shown in FIG. 13, the transmit end uses a plurality of synchronization sequences in a superframe header for sending on four frequencies. The plurality of synchronization sequences may be the same or may be different. The transmit end transmits a radio frame in a fixed frequency hopping mode. The receive end may obtain and store a frequency hopping mode in advance. For example, the receive end may negotiate the frequency hopping mode with the transmit end in advance, or specify the frequency hopping mode in a protocol.

After receiving the uplink signal, the receive end performs synchronization and frequency offset compensation on four frequencies to determine a location of a data frame, and performs channel estimation and decoding in the frequency hopping mode.

The transmit end transmits a radio frame in a fixed frequency hopping mode, or certainly may transmit a radio frame in an unfixed frequency hopping mode. When the radio frame is transmitted in the unfixed frequency hopping mode, different frequency hopping modes may be implicitly indicated by scrambling a synchronization sequence. For example, when the synchronization sequence is scrambled by using a scrambling sequence 1, the scrambling sequence 1 indicates a frequency hopping mode 1. For another example, when the synchronization sequence is scrambled by using a scrambling sequence 2, the scrambling sequence 2 indicates a frequency hopping mode 2. After receiving the uplink signal, the network device performs descrambling and synchronization operations on the uplink signal by using different scrambling sequences. A frequency hopping mode corresponding to a scrambling sequence with a largest cross-correlation amplitude is a frequency hopping mode used by the terminal device.

In this embodiment of this application, the transmit end and the receive end may pre-negotiate a system parameter for signal transmission, or may specify a system parameter for signal transmission according to a protocol. The system parameter may include one or more of the frame structure, the frequency hopping mode, or the parameter in the control information. The system parameter may further include some other parameters. For example, the system parameter may further include one or more of a bandwidth, a subcarrier spacing, a waveform, an MCS, an encoding scheme, a baseband sampling rate, a sampling time interval, single-carrier transmission, and the like.

For example, the bandwidth and the subcarrier spacing each are 60 kHz, the waveform uses SC-FDMA, the terminal sends information in a single-port mode, and a polar code is used for channel encoding. The baseband sampling rate is 1.92 MHz, and the sampling time interval is

$$Ts = \frac{1}{1.92 MHz} \approx 0.52 µs .$$

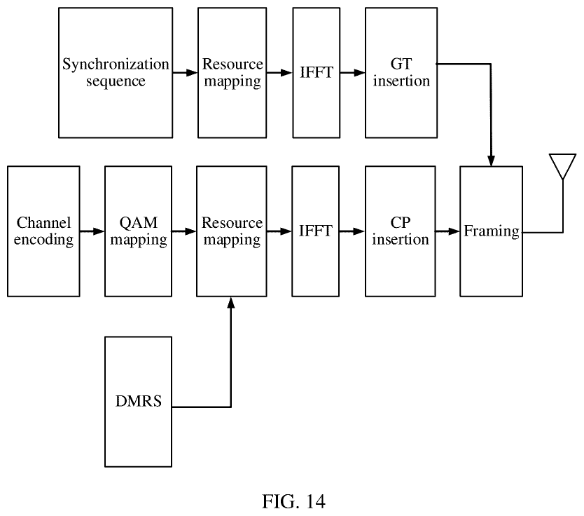

A process in which the transmit end generates the uplink signal may be operation steps shown in FIG. 14. For example, the transmit end performs channel encoding on sent data, and performs mapping, DMRS addition, inverse fast Fourier transform (IFFT) transformation, and CP addition based on encoded data, to form a data frame. After mapping and IFFT are performed on 37 M-sequences, a guard interval is added to a tail to form a synchronization sequence.

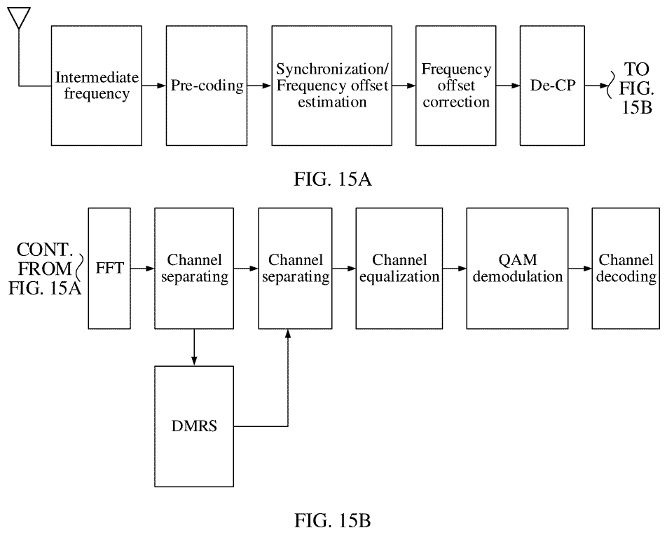

Correspondingly, after receiving the uplink signal, the receive end may perform operation steps shown in FIG. 15A and FIG. 15B. For example, the receive end performs uplink synchronization and frequency offset estimation based on the synchronization sequence, removes, based on a CP length, some CP sampling points from a time-domain signal obtained after timing and frequency offset compensation, and separates a data symbol from a DMRS symbol based on a slot structure. Finally, the receive end performs channel estimation and equalization, and sends information to a decoder for decoding.

It should be noted that examples in the application scenarios in this application merely show some possible implementations, to help better understand and describe the method in this application. Persons skilled in the art may obtain examples of some evolved forms according to the narrowband internet of things-based communication method provided in this application.

To implement functions in the foregoing method provided in embodiments of this application, the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

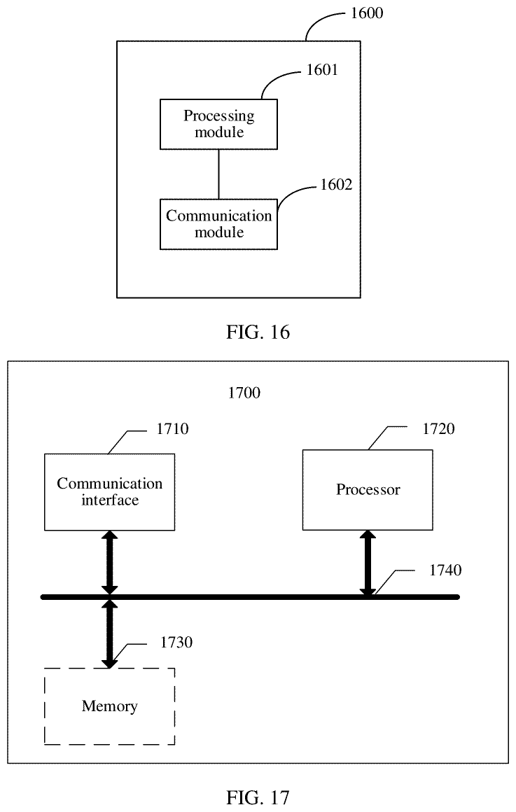

As shown in FIG. 16, based on a same technical concept, an embodiment of this application further provides a communication apparatus 1600. The communication apparatus 1600 may be a terminal device, or may be a function component, a module, or the like in the terminal device, or may be another apparatus that can be used with the terminal device in a matching manner. In a design, the communication apparatus 1600 may include modules that are in a one-to-one correspondence with the methods/operations/steps/actions performed by the terminal device in the foregoing method embodiment. The module may be implemented by a hardware circuit, software, or a combination of the hardware circuit and the software. In a design, the communication apparatus 1600 may include a processing module 1601 and a communication module 1602.

When the communication apparatus 1600 is configured to perform operations performed by the terminal device, the processing module 1601 is configured to generate an uplink signal, where a frame structure of the uplink signal includes a superframe, one superframe includes a synchronization sequence and a data frame, the synchronization sequence is located in first duration of the superframe, the data frame is located in second duration of the superframe, the first duration of the superframe is before the second duration, the synchronization sequence is formed by repeating a sequence of a type N times, the synchronization sequence successively includes a first sequence repeated N1 times and a second sequence repeated N2 times, the second sequence is obtained by multiplying the first sequence by −1, a part of consecutive sequences of the synchronization sequence are used as a first synchronization reference sequence, the first synchronization reference sequence is obtained based on the second sequence repeated N2 times and one or more first sequences that are sorted from back to front in the first sequence repeated N1 times, N, N1, and N2 are all positive integers, N is greater than 2, and N2 is greater than 1; and the communication module 1602 is configured to send the uplink signal to a network device.

The processing module 1601 and the communication module 1602 may be further configured to perform other corresponding operations performed by the terminal device in the foregoing method embodiment. Details are not described herein again.

When the communication apparatus 1600 is configured to perform operations performed by the network device, the communication module 1602 is configured to receive an uplink signal, where a frame structure of the uplink signal includes a superframe, one superframe includes a synchronization sequence and a data frame, the synchronization sequence is located in first duration of the superframe, the data frame is located in second duration of the superframe, the first duration of the superframe is before the second duration, the synchronization sequence is formed by repeating a sequence of a type N times, the synchronization sequence successively includes a first sequence repeated N1 times and a second sequence repeated N2 times, the second sequence is obtained by multiplying the first sequence by −1, a part of consecutive sequences of the synchronization sequence are used as a first synchronization reference sequence, the first synchronization reference sequence may be obtained based on the second sequence repeated N2 times and one or more first sequences that are sorted from back to front in the first sequence repeated N1 times, in other words, the first synchronization reference sequence includes the second sequence repeated N2 times and the one or more first sequences connected to the second sequence repeated N2 times, N, N1, and N2 are all positive integers, N is greater than 2, and N2 is greater than 1; and the processing module 1601 is configured to perform uplink synchronization based on a second synchronization reference sequence and the uplink signal.

The processing module 1601 is further configured to: perform cross-correlation between the uplink signal and each of a plurality of second synchronization reference sequences, to obtain cross-correlation amplitudes corresponding to the plurality of second synchronization reference sequences, where the plurality of second synchronization reference sequences are in a one-to-one correspondence with a plurality of subcarrier spacings; and determine a subcarrier spacing corresponding to a second synchronization reference sequence with a largest cross-correlation amplitude as a subcarrier spacing used by a terminal device.

The processing module 1601 is further configured to: descramble the uplink signal by using a plurality of scrambling sequences, to obtain a plurality of descrambled signals corresponding to the plurality of scrambling sequences, where the plurality of scrambling sequences are in a one-to-one correspondence with a plurality of subcarrier spacings; perform cross-correlation between each of the plurality of descrambled signals and the second synchronization reference sequence, to obtain a plurality of cross-correlation amplitudes corresponding to the plurality of scrambling sequences; and determine a subcarrier spacing corresponding to a scrambling sequence with a largest cross-correlation amplitude as a subcarrier spacing used by a terminal device.

The processing module 1601 and the communication module 1602 may be further configured to perform other corresponding operations performed by the network device in the foregoing method embodiment. Details are not described herein again.

Module division in embodiments of this application is an example, and is merely logical function division. During actual implementation, there may be another division manner. In addition, function modules in embodiments of this application may be integrated into one processor, or each of the modules may exist alone physically, or two or more modules may be integrated into one module. The integrated module may be implemented in a form of hardware, or may be implemented in a form of a software functional module.

FIG. 17 shows a communication apparatus 1700 according to an embodiment of this application. The communication apparatus 1700 is configured to implement functions of the terminal device or the network device in the foregoing method. When implementing the functions of the terminal device, the communication apparatus 1700 may be the terminal device, an apparatus in the terminal device, or an apparatus that can be used with the terminal device in a matching manner. When implementing the functions of the network device, the communication apparatus 1700 may be the network device, an apparatus in the network device, or an apparatus that can be used with the network device in a matching manner. The communication apparatus may be a chip system. In this embodiment of this application, the chip system may include a chip, or may include a chip and another discrete component. The communication apparatus 1700 includes at least one processor 1720, configured to implement the functions of the terminal device or the network device in the method provided in the embodiment of this application. The communication apparatus 1700 may further include a communication interface 1710. The communication interface 1710 may be a transceiver, a circuit, a bus, a module, or a communication interface of another type, and is configured to communicate with another device by using a transmission medium. For example, the communication interface 1710 is used by the communication apparatus 1700 to communicate with the another device.

The communication apparatus 1700 may further include at least one memory 1730. The memory 1730 is configured to store program instructions and/or data. The memory 1730 is coupled to the processor 1720. The coupling in this embodiment of this application may be an indirect coupling or a communication connection between apparatuses, units, or modules in an electrical form, a mechanical form, or another form, and is used for information exchange between the apparatuses, the units, or the modules. The processor 1720 may cooperate with the memory 1730. The processor 1720 may execute the program instructions stored in the memory 1730. At least one of the at least one memory may be included in the processor. The processor 1720 may be implemented by using a logic circuit. A specific form includes but is not limited to any one of the following:

The processor 1720 may be a central processing unit (CPU), a network processor (NP), or a combination of a CPU and an NP. The processor 1720 may be implemented by using a logic circuit. A specific form of the logic circuit includes but is not limited to any one of the following: a field programmable gate array (FPGA), a very high-speed integrated circuit hardware description language (VHDL) circuit, or a complementary pass transistor logic (CPL) circuit.

When the communication apparatus 1700 is configured to perform an operation performed by the terminal device, the processor 1720 is configured to generate an uplink signal, and the communication interface 1710 is configured to send the uplink signal to a network device. For an explanation of the uplink signal, refer to the foregoing explanation of the uplink signal. Details are not described herein again.

When the communication apparatus 1700 is configured to perform an operation performed by the network device, the communication interface 1710 is configured to receive an uplink signal, and the processor 1720 is configured to perform uplink synchronization based on a synchronization sequence. For an explanation of the uplink signal, refer to the foregoing explanation of the uplink signal. Details are not described herein again.

The processor 1720 is further configured to perform other operations and steps performed by the terminal device or the network device in the foregoing method embodiment.

A specific connection medium between the communication interface 171o, the processor 1720, and the memory 1730 is not limited in this embodiment of this application. In this embodiment of this application, the memory 1730, the processor 1720, and the communication interface 1710 are connected through a bus 1740 in FIG. 17. The bus is represented by using a thick line in FIG. 17. A manner of a connection between other components is merely an example for description, and is not limited thereto. The bus may be classified into an address bus, a data bus, a control bus, and the like. For ease of representation, only one thick line is used to represent the bus in FIG. 17, but this does not mean that there is only one bus or only one type of bus.

In this embodiment of this application, the memory 1730 may be a non-volatile memory, such as a hard disk drive (HDD) or a solid-state drive (SSD), or may be a volatile memory, such as a random access memory (RAM). The memory is any other medium that can carry or store expected program code in a form of an instruction or a data structure and that can be accessed by a computer, but is not limited thereto. The memory in this embodiment of this application may alternatively be a circuit or any other apparatus that can implement a storage function, and is configured to store the program instructions and/or the data.

Some or all of the operations and functions performed by the terminal device/network device described in the foregoing method embodiments of this application may be implemented by using a chip or an integrated circuit.

To implement the functions of the communication apparatus in FIG. 16 or FIG. 17, an embodiment of this application further provides a chip, including a processor, configured to support the communication apparatus in implementing the functions of the terminal device or the network device in the foregoing method embodiment. In a possible design, the chip is connected to a memory or the chip includes a memory, and the memory is configured to store program instructions and data that are necessary for the communication apparatus.

An embodiment of this application provides a computer-readable storage medium storing a computer program, and the computer program includes instructions used to perform the foregoing method embodiments.

An embodiment of this application provides a computer program product including instructions, and when the computer program product runs on a computer, the computer is enabled to perform the foregoing method embodiments.

Persons skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so as to generate computer-implemented processing. Therefore, the instructions executed on the computer or the another programmable device provide steps for implementing a specific function in one or more processes in the flowcharts and/or in one or more blocks in the block diagrams.

Although some embodiments of this application have been described, persons skilled in the art can make changes and modifications to these embodiments once they learn of the basic inventive concept. Therefore, the following claims are intended to be construed as to cover the preferred embodiments and all changes and modifications falling within the scope of this application.

It is clear that persons skilled in the art can make various modifications and variations to embodiments of this application without departing from the scope of embodiments of this application. This application is also intended to cover these modifications and variations provided that they fall within the scope of protection defined by the following claims and their equivalent technologies.

What is claimed is:

1. A method, applied to a non-terrestrial network (NTN), the method comprising:
generating, by a first communication apparatus, an uplink signal, wherein a frame structure of the uplink signal comprises a superframe, a synchronization sequence is located in a first duration of the superframe, a data frame is located in a second duration of the superframe, the first duration is before the second duration, the synchronization sequence successively comprises a first sequence repeated N1 times and a second sequence repeated N2 times, the second sequence is obtained by multiplying the first sequence by −1, a part of consecutive sequences of the synchronization sequence provides a first synchronization reference sequence, the first synchronization reference sequence is obtained based on the second sequence repeated N2 times and one or more first sequences that are sorted from back to front in the first sequence repeated N1 times, N, N1, and N2 are all positive integers, N is greater than 2, and N2 is greater than 1; and
sending, by the first communication apparatus, the uplink signal to a network device.

2. The method according to claim 1, wherein a subcarrier spacing that generates the uplink signal is 60 kHz, a length of the first duration is 40 ms, a length of the second duration is 60 ms, the data frame comprises six radio frames, and a length of each of the six radio frames is 10 ms.

3. The method according to claim 2, wherein the first sequence and the second sequence each are a Golay sequence whose length is 64, N1 is 32, and N2 is 5.

4. The method according to claim 2, wherein the first sequence and the second sequence each are an M-sequence whose length is 63, and a sum of N1 and N2 is 38.

5. The method according to claim 1, wherein a subcarrier spacing that generates the uplink signal is 15 kHz, a length of the first duration is 20 ms, a length of the second duration is 80 ms, the data frame comprises two radio frames, and a length of each of the two radio frames is 40 ms.

6. The method according to claim 5, wherein:
the first sequence and the second sequence each are a Golay sequence whose length is 16, and a sum of N1 and N2 is 18; or
the first sequence is an M-sequence whose length is 15, and a sum of N1 and N2 is 20.

7. The method according to claim 1, wherein the first sequence and the second sequence each are an M-sequence whose length is 15, and a sum of N1 and N2 is 20.

8. The method according to claim 1, wherein a subcarrier spacing that generates the uplink signal is 30 kHz, a length of the first duration is 40 ms, a length of the second duration is 60 ms, the data frame comprises three radio frames, and a length of each of the three radio frames is 20 ms.

9. The method according to claim 8, wherein the first sequence and the second sequence each are a Golay sequence whose length is 32, and a sum of N1 and N2 is 37.

10. The method according to claim 8, wherein the first sequence and the second sequence each are an M-sequence whose length is 31, and a sum of N1 and N2 is 38.

11. The method according to claim 1, wherein the data frame in the superframe of the uplink signal comprises one or more radio frames, a 1^{st} radio frame in the one or more radio frames carries second control information, and the second control information indicates a quantity of times of repeated transmission of the superframe.

12. The method according to claim 1, wherein transmission between a plurality of superframes to implement transmission of the uplink signal is performed with a first frequency hopping mode; or
the synchronization sequence is transmitted in the superframe with a second frequency hopping mode, the data frame comprises one or more radio frames, and the one or more radio frames are transmitted in the superframe with a third frequency hopping mode.

13. The method according to claim 1, wherein the uplink signal is transmitted based on a single carrier.

14. A method, applied to a non-terrestrial network (NTN), the method comprising:
receiving, by a second communication apparatus, an uplink signal, wherein a frame structure of the uplink signal comprises a superframe, a synchronization sequence is located in a first duration of the superframe, a data frame is located in a second duration of the superframe, the first duration of the superframe is before the second duration, the synchronization sequence successively comprises a first sequence repeated N1 times and a second sequence repeated N2 times, the second sequence is obtained by multiplying the first sequence by −1, a part of consecutive sequences of the synchronization sequence provides a first synchronization reference sequence, the first synchronization reference sequence is obtained based on the second sequence repeated N2 times and one or more first sequences that are sorted from back to front in the first sequence repeated N1 times, N, N1, and N2 are all positive integers, N is greater than 2, and N2 is greater than 1; and
performing, by the second communication apparatus, uplink synchronization based on a second synchronization reference sequence and the uplink signal.

15. The method according to claim 14, wherein the second synchronization reference sequence is one of a plurality of second synchronization reference sequences; and the method further comprises:
performing, by the second communication apparatus, cross-correlation between the uplink signal and each of the plurality of second synchronization reference sequences, to obtain cross-correlation amplitudes corresponding to the plurality of second synchronization reference sequences, wherein the plurality of second synchronization reference sequences are in a one-to-one correspondence with a plurality of subcarrier spacings; and
determining, by the second communication apparatus, a subcarrier spacing corresponding of the plurality of subcarrier spacings to a second synchronization reference sequence of the plurality of second synchronization reference sequences with a largest cross-correlation amplitude as a subcarrier spacing for a terminal device.

16. The method according to claim 14, wherein the method further comprises:
descrambling, by the second communication apparatus, the uplink signal based on a plurality of scrambling sequences, to obtain a plurality of descrambled signals corresponding to the plurality of scrambling sequences, wherein the plurality of scrambling sequences are in a one-to-one correspondence with a plurality of subcarrier spacings;
performing, by the second communication apparatus, cross-correlation between each of the plurality of descrambled signals and the second synchronization reference sequence, to obtain a plurality of cross-correlation amplitudes corresponding to the plurality of scrambling sequences; and
determining, by the second communication apparatus, a subcarrier spacing of the plurality of subcarrier spacings corresponding to a scrambling sequence of the plurality of scrambling sequences with a largest cross-correlation amplitude as a subcarrier spacing for a terminal device.

17. The method according to claim 14, wherein:
a first superframe of the uplink signal carries first control information, and the first control information indicates a subcarrier spacing for transmission of another superframe after the first superframe.

18. The method according to claim 14, wherein a subcarrier spacing that generates the uplink signal is 60 kHz, a length of the first duration is 40 ms, a length of the second duration is 60 ms, the data frame comprises six radio frames, and a length of each radio frame is 10 ms.

19. A communication apparatus, comprising one or more processors, wherein one or more processors is configured to execute instructions that cause the communication apparatus to:
generate an uplink signal, wherein a frame structure of the uplink signal comprises a superframe, a synchronization sequence is located in a first duration of the superframe, a data frame is located in a second duration of the superframe, the first duration is before the second duration, the synchronization sequence successively comprises a first sequence repeated N1 times and a second sequence repeated N2 times, the second sequence is obtained by multiplying the first sequence by −1, a part of consecutive sequences of the synchronization sequence provides a first synchronization reference sequence, the first synchronization reference sequence is obtained based on the second sequence repeated N2 times and one or more first sequences that are sorted from back to front in the first sequence repeated N1 times, N, N1, and N2 are all positive integers, N is greater than 2, and N2 is greater than 1; and
send the uplink signal to a network device.

20. The communication apparatus according to claim 19, further comprising a non-transitory memory, wherein the non-transitory memory stores the instructions run by the one or more processors.
